(19) United States
(12) Patent Application Publication
(10) Pub. No.: US 2007/0084944 A1
(43) Pub. Date: Apr. 19, 2007

(54) Methods for aligning a device and for stacking two devices in an aligned manner and device for improved stacking

(76) Inventors: Harry Hedler, Germering (DE); Roland Irsigler, Munchen (DE); Thorsten Meyer, Regensburg (DE)

Correspondence Address: PATTERSON & SHERIDAN, LLP;Gero McClellan / Infineon / Qimonda, 3040 POST OAK BLVD.,, SUITE 1500, HOUSTON, TX, 77056, US

(21) Appl. No.: 11/251,596

(22) Filed: Oct. 14, 2005

(51) Int. Cl. A01G 25/09; B05B 17/04; B05B 17/00

(52) U.S. Cl. 239/11; 239/1; 239/4

(57) ABSTRACT

Method and apparatus for aligning components of a device. In one embodiment a method of aligning includes providing a device having a surface on which a number of adjusting structures is provided in predetermined regions, wherein each of the adjusting structures of the device has a first region having a first wettability and a second region having a second wettability, wherein the second wettability is lower than the first wettability. A number of liquid droplets is provided in a fixed arrangement which corresponds to the arrangement of the adjusting structures in the predetermined regions of the device. The device is placed on the liquid droplets in such a way that each of the droplets abuts at least partially on the inner region of the corresponding adjusting structure of the device in such a way that the device is aligned with regard to the arrangement of the number of droplets.

### BACKGROUND OF THE INVENTION

1. Field of the Invention

The present invention relates to methods for aligning a device and for stacking two devices in an aligned manner. The present invention relates to a device which is adapted to be stacked with another device in a more precise manner.

2. Description of the Related Art

To increase the performance of integrated circuit devices, a single device can include more than one chip. Such so-called multichip devices usually comprise a number of chips stacked onto each other on a redistribution substrate which provides contact elements for externally contacting the multichip device. In an automated production line, such multichip devices are manufactured by a conventional pick-and-place process wherein a chip is picked up, moved to the position of the multichip device to be assembled and placed in its predetermined position. The placing of the chips usually has a limited precision. Contact pads on the chip have to be placed on respective corresponding contact structures with a precision defined by the pitch of the contact pads and their sizes. A further shrinking of the pitch of the contact pads and the sizes of the contact pads is thereby limited by the maximum position accuracy of the pick-and-place tool used in the manufacturing lines. To replace pick-and-place tools in manufacturing lines by more accurate ones is expensive and a more accurate placing of a chip in the multichip device to be built requires more time which lowers the production throughput.

### SUMMARY OF THE INVENTION

According to some embodiments of the present invention a method is provided for aligning a device with an improved position accuracy wherein the modification of the conventional pick-and-place technology is not necessarily required. In another embodiment, provides a method for stacking two devices onto each other with a precise alignment.

Another embodiment provides a device which is adapted to allow stacking thereof with an improved precision.

According to a first aspect of the present invention, a method for aligning a device is provided, comprising the steps of providing the device having a surface on which a number of adjusting structures is provided in predetermined regions, wherein each of the adjusting structures of the device has a first region having a first wettability and a second region having a second wettability, wherein the second wettability is lower than the first wettability; of providing a number of liquid droplets in a fixed arrangement which corresponds to the arrangement of the adjusting structures in the predetermined regions of the device; and of placing the device on the liquid droplets in such a way that each of the droplets abuts at least partially on the inner region of the corresponding adjusting structure of the device in such a way that the device is aligned with regard to the arrangement of the number of droplets.

The method of the present invention allows for aligning of a device in a more precise manner than it is currently possible by means of conventional pick-and-place tools used for assembling multichip arrangements. The precise alignment is achieved by using the surface energy of a liquid droplet which is placed on a boundary between regions of different wettability of a device surface. The first and second region define the position to which the device is to be aligned. By placing the device on the droplets, a lateral force between the droplet and the device is exerted if the boundary between the first and second region of the adjusting structure is placed onto the droplet such that the droplets wets the first and second region partially. As the device floats on the droplet, the device can move into the aligned position defined by the fixed arrangement of the droplets and the arrangement of the adjusting structures on the surface of the device. As the adjusting structure can be provided on the surface of the device in a more precise manner, it is possible to place the device in a predetermined location and alignment by means of a pick-and-place tool. The method of the present invention allows the aligning of the device with an improved precision.

According to a preferred embodiment of the present invention, the liquid of the droplets is selected in such a way that its surface tension allows that the device is held on the number of droplets so that the device may float freely on the droplets. Furthermore, the number and the size of the droplets and of the adjusting structures are selected in such a way that the device may be merely held on the droplets so that the device floats freely on the droplets.

Preferably, the size of the droplet is selected depending on the weight of the device to be aligned.

According to another embodiment of the present invention, the step of removing the droplet so that the device is lowered in its aligned condition. Particularly, the droplet is removed by evaporating the liquid of the droplet.

According to another embodiment of the present invention, a method for stacking two devices in an aligned manner is provided. The method comprises the steps of providing a first device and a second device each having a surface on which a number of adjusting structures is provided in predetermined regions, wherein the arrangements of the adjusting structures on both surfaces are mirrored, wherein each of the adjusting structures of each of the first and second devices has a first region having a first wettability and a second region having a second wettability, wherein the second wettability is lower than the first wettability. The method further comprises the steps of applying a number of liquid droplets at least partially on the first region of each of the adjusting structures of the first device in such a way that each of the number of droplets is aligned to its first region, and of placing the second device on the liquid droplets in such a way that each of the droplets abuts at least partially on the first region of the corresponding adjusting structure of the second device in such a way that the second device is aligned with regard to the arrangement of the droplets.

The method of the present invention allows a stacking of two devices in an aligned manner wherein the aligning of the second device on the first device can be performed with a higher precision than is possible by using conventional pick-and-place technologies. This can be achieved by using the surface energy (surface tension) of liquid droplets which are in a first step put on respective adjusting structures on a surface of the first device wherein the droplets are aligned with respect to the adjusting structures. In a second step a second device is placed on the droplets in such a way that its adjusting structure is placed close to droplets so that the surface tension of the droplets results in a lateral force which moves the second device, which floats onto the droplets, into the desired aligned condition.

According to an embodiment of the present invention, the liquid of the droplets is selected having a surface tension which allows that the second device is spaced from the first device merely due to the surface tension of the droplet by a predetermined height when the number of droplets is aligned in the first regions of the adjusting structures of the first and second devices.

Preferably, the number and the size of the droplets are selected in such a way that the first and the second device are spaced from one another by a predetermined height when the number of droplets is aligned to the first regions of the adjusting structures of the first and second devices.

Furthermore, the size of the droplet may be selected according to the weight of the second device, so that the second device floats freely on the droplets on the first device. In one embodiment, the droplet is removed in such a way that the second device is lowered onto the first device. In particular, the droplet is removed by evaporating the liquid of the droplet.

According to a further aspect of the present invention, a method for stacking two devices in an aligned manner is provided. The method comprises the steps of providing a first device having a first surface on which a first adjusting structure is provided, wherein the first adjusting structure has a first region having a first wettability and a second region having a second wettability, wherein the second wettability is lower than the first wettability; of applying a droplet at least partially in the first region of the first adjusting structure in such a way that the droplet is aligned to the first region as an effect of the wettability; of providing a second device having a second surface on which a second adjusting structure is provided, wherein the adjusting structure has a third region having a third wettability and a fourth region having a fourth wettability; wherein the fourth wettability is lower than the third wettability; and of arranging the second device on the liquid droplet in such a way that the droplet abuts at least partially on the third region of the adjusting structure of the second device in such a way that the second device is aligned with regard to the droplet.

According to a further aspect of the present invention, a device is provided comprising a plane substrate, a number of adjusting structures arranged on the surface of the plane substrate wherein each of the number of adjusting structures having a first region having a first wettability and a second region having a second wettability, wherein the second wettability is lower than the first wettability.

A device according to one embodiment of the present invention is provided with adjusting structures which allow the aligning of the device with regard to liquid droplets with a higher precision as the device is self-aligning when placed on liquid droplets with a lower precision.

According to one embodiment of the present invention, the second region of at least one of the adjusting structures on the surface is arranged surrounding the first region. In a particular embodiment, the first region may be circular.

The first region may have a size which depends on at least one of the number of adjusting structures, the first wettability, the second wettability, and the material of the liquid droplet.

A hold element may be provided on the substrate which forms at least one of a recess and an elevation. The hold element can be used to fix a device after its aligning in order to maintain the precise alignment.

According to another embodiment of the present invention, a device stack is provided which comprises a first device including a first substrate and a number of first adjusting structures arranged on a first surface of the first substrate, wherein each of the number of first adjusting structures has a first region having a first wettability and a second region having a second wettability, wherein the second wettability is lower than the first wettability; and a second device including a second substrate and a number of second adjusting structures arranged on a second surface of the second substrate, wherein each of the number of the second adjusting structures has a third region having a third wettability and a fourth region having a fourth wettability, wherein the fourth wettability is lower than the third wettability, wherein the first and the second devices are stacked in such a way that the first and second surfaces face each other and the first adjusting structures and the second adjusting structures are aligned to each other.

The package stack according to one embodiment of the present invention is the result of the aligning process so that the aligning structures of the first and the second devices have been aligned to each other.

The device stack may include a first holding element arranged on the first surface and a second holding element arranged on the second surface, wherein the first and second holding elements engage each other. The holding elements allow for fixing of the first and second devices onto each other in order to prevent a lateral slipping of the devices.

Preferably, the first and third wettability are different and/or the second and fourth wettability are different from each other.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other objects and features of the present invention will become clear from the following description taken in conjunction with the accompanying drawings in which:

FIGS. 1A to 1D illustrate the physical effect the present invention utilizes used for a droplet onto a surface of a first device, according to one embodiment of the invention;

FIGS. 2A to 2C illustrate the method for aligning a second device with regard to the first device, according to one embodiment of the invention;

FIG. 3A to 3D show the steps for fixing the devices onto each other in an aligned condition, according to one embodiment of the invention;

FIGS. 4A to 4D show another embodiment for fixing the devices onto each other in an aligned condition, according to one embodiment of the invention;

FIG. 5A and 5B show the steps for providing an electrical interconnection between the devices when the devices are aligned by the steps shown in the embodiment of FIGS. 3A to 3D, according to one embodiment of the invention;

FIG. 6A and 6B show the provision of an interconnection between the devices when the devices have been aligned by the steps shown in the embodiment of FIGS. 4A to 4D , according to one embodiment of the invention; and

FIG. 7A and 7B illustrate the term “wettability” of a surface, according to one embodiment of the invention.

### DETAILED DESCRIPTION OF THE PREFERRED EMBODIMENT

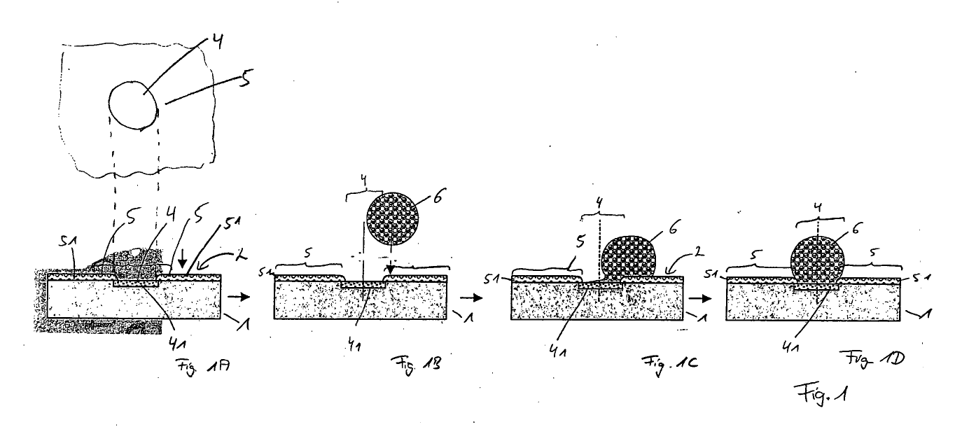

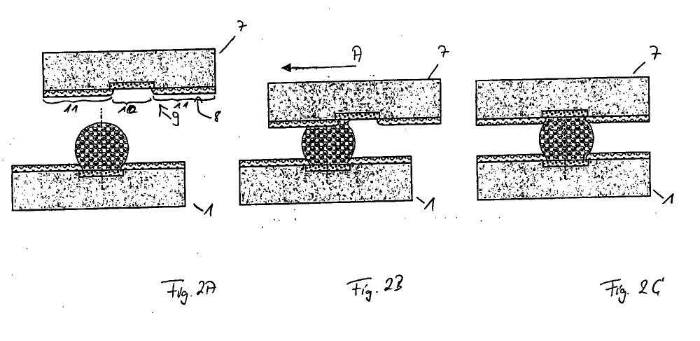

In the following, a method for aligning two devices onto each other with high precision is described. The first steps of the present invention are shown in FIGS. 1A to 1C. These are used simultaneously in order to explain the physical effect of the present invention. In FIG. 1A, a first device 1 is depicted in a top view and a cross-sectional view. The first device 1 has a surface 2 on which an adjusting structure 3 is provided. The adjusting structure has a first region 4 and a second region 5 wherein the first region 4 is located in the centre of the second region 5 so that the second region 5 surrounds the first region 4. In the first region 4, a first material layer 41 is provided on the substrate 1 having a first wettability and in the second region 5 a second material layer 51 is provided, having a second wettability wherein the second wettability is lower than the first wettability.

As can be seen in FIG. 1B, a liquid droplet 6 is applied onto the adjusting structure 3 of the surface 2 of the first device 1 so that in the contact region between the liquid droplet 6 and the first device 1 a boundary between the first and the second regions 4, 5 is included. This is shown in FIG. 1C. The liquid droplet 6 has a surface energy which results in that the liquid of the droplet wets the second region 5 and thereafter is moved towards the first region 4 which has the higher wettability with the liquid of the droplet 6 such that a lower energy state can be achieved. This is shown in FIG. 1D wherein the liquid droplet 6 is aligned to the first region 4 of the adjusting structure 3 such that the liquid droplet 6 is precisely aligned with regard to the adjusting structure 3.

The first and second wettability as well as the material of the liquid are adapted such that the liquid forms a droplet on the second region 5 having a second wettability and which droplet is moved to the first region 4 when the liquid droplet at least partially covers and comes into contact with the first region 4 of the adjusting structure 3. In one material system, the liquid of the droplet comprises water, and more preferably purified water. In one embodiment, the first material layer is provided as a material layer which is more hydrophilic than the second material layer and the second material layer is provided as a material layer which is more hydrophobic than the first material layer. Other material systems are possible as well if they provide the desired lateral movement of a liquid droplet on a surface having two different wettabilities as a result of the surface energy of the liquid.

The shape of the first region 4 is preferably circular but other shapes of the first region of the adjustment structure 3 are possible as well. The first region 4 may be located in a recess on the surface 2 of the first device 1 such that the lateral movement of the droplet 6 is further effected by gravity acting on the droplet.

The size of the first region 4 may be adapted to the size of the liquid droplet 6 so that the contact surface of the liquid droplet 6 on the first region 4 having the first wettability substantially completely fills the first region 4 without having any more freedom for a lateral movement within the first region 4 so that the droplet 6 which is aligned to the adjusting structure 3 is held in a precisely defined position. In one embodiment, the size of the first region 4 exactly equals or is slightly smaller than the size of the contact region the droplet 6 would have on a surface having a first wettability without being in contact with a surface having a different wettability therefrom.

As the adjustment structure having its first and second region 4, 5 can be patterned on the surface of the first device 1 with a very high precision using lithography techniques well known in the art, the droplets 6 which are to be aligned to the adjusting structure 3 can be positioned on the surface of the first device with a precision which substantially equals the positioning precision of the adjusting structure 3 pattern. The placement of the liquid droplet can be performed by a dispense tool and the like. The positioning of the droplet 6 can be achieved in spite of the lower precision of the placement of the droplet provided that the droplet is placed on the adjusting structure 3 such that its contact surface is at least partially in contact with the first region of the adjusting structure. Thereby, it can be achieved that the liquid droplet 6 may be placed on the surface of the first device 1 with a far lower precision without affecting the final precise position of the droplet. Consequently, conventional dispense tools for placing the droplet which has a lower position accuracy can be used which makes the process for dispensing the droplet more cost efficient in a high yield mass production.

In FIGS. 2A to 2C, a process of aligning a second device 7 on the first device 1 is illustrated. In FIG. 2A, the provision of the second device 7 is shown, the second device 7 having a surface 8 on which a second adjusting structure 9 is arranged. The size and the shape of the second adjusting structure 9 is preferably formed similar to the size and shape of the first adjusting structure 3 having a third region 10 and a fourth region 11. The third region 10 is shaped surrounded by the fourth region 11 as already described with regard to the adjusting structure 3 of the first device 1. The second device 7 is provided upside down so that the surface 8 including the second adjusting structure 9 faces the surface including the first adjusting structure 3. The second device 7 is lowered onto the droplet 6 on the first device 1 until the droplet 6 comes into contact with the adjusting structure 9 on the second surface 8 of the second device 7. This is shown in FIG. 2B. The precision of placing the second device onto the droplet 6 should be such so as to ensure that the contact surface of the droplet 6 on the second adjusting structure 9 at least partially covers the third region 10 of the second adjusting structure 9.

The second device 7 and the droplet 6 are adapted in such a way that the second device 7 floats freely on the droplet which means that the material of the droplet, i.e. its surface tension (surface energy), the weight of the second device 7 as well as the wettabilities of the third and fourth regions 10, 11 of the second adjusting structure 9 are selected so that the second device 7 is held floating on the droplet 6 and does not flatten the droplet 6 to an extent that the surface 2 of the first device 1 and the surface 8 of the second device 7 abut at each other. The free floating of the second device 7 on the droplet 6 allows for aligning the second device 7 with regard to the droplet 6 which is itself aligned to the first adjustment structure 3 on the first surface 2 of the first device 1. Consequently, the first adjusting structure 3 of the first device 1 and the second adjusting structure 9 of the second device 7 are aligned to each other by means of the droplet 6 so that the first and second devices 1, 7 are aligned to each other.

In order to provide a free floating of the second device 7 on the first device 1, it may be necessary that two or more first adjusting structures 3 and corresponding second adjusting structures 9 on the second device 7 are provided so that the device floats on two or more droplets 6 which are distributed on the surface 2 of the first device 1. The material of the liquid of the droplet its size, the wettability of the first material layer 41 and the second material layer 51, the number of droplets and the total weight of the second device 7 as well as the wettabilities of the third and the fourth regions 10, 11 of the second adjusting structures 9 of the second device 7 are adapted so that the second device 7 can float freely on the droplets 6 preferably without any further support.

The arrangement of the first adjusting structures on the surface 2 of the first device 1 corresponds substantially to the arrangement of the second adjusting structures 9 of the second device 7 so that the second adjusting structures 9 are mirrored in their arrangement with respect to the arrangement of the first adjusting structures 3 of the first device 1.

As shown in FIG. 2B prior to the placing of the second device 7 on the droplet 6 in the above described manner the second device 7 is exposed to a lateral force (indicated by arrow A) which tends to move the second device 7 in an aligned position with regard to the arrangement of the droplets 6 (see FIG. 2C).

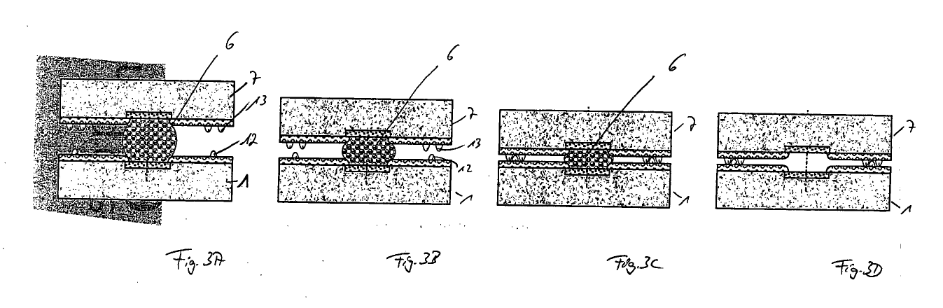

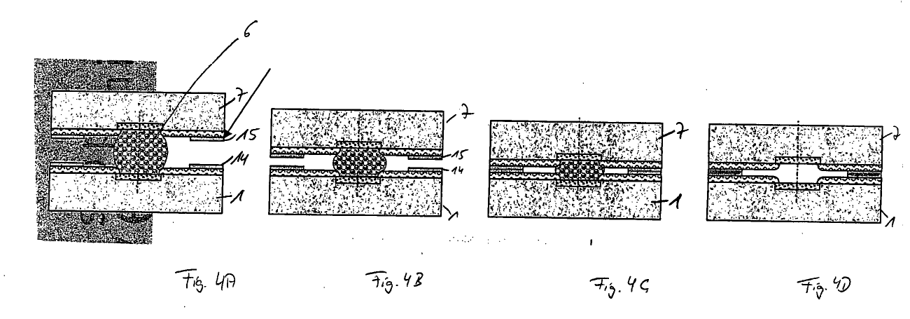

In FIGS. 3A to 3D, the placing of the second device 7 on the first device 1 is illustrated. Starting from the state of FIG. 3A in which the first device 1 and the second device 7 are aligned to each other and spaced from each other by means of the droplet 6, the removal of the droplet between the first and the second device 1, 7 is started by evaporating the liquid of the droplet 6. In case the droplet 6 contains purified water, the evaporation of the droplet can be performed by applying heat, microwaves and such like. While evaporating the droplet, the second device 7 is lowered onto the first device 1 (FIG. 3B) until the second device 7 gets into contact with the surface of the first device 1 such that a mechanical contact is reached (FIG. 3C). To prevent the second device 7 from sliding on the surface 2 of the first device 1, one or more first support elements 12 are provided on the surface 2 of the first device 1 and one or more second support elements 11 are provided on the second surface 8 of the second device 7. The first and second support elements 12, 13 also referred to as hold elements are adapted so that they engage each other if the first and second devices 1, 7 are in an aligned condition and the droplet is removed such that the second device 7 is lowered onto the first device 1.

The first and second support elements 12, 13 can be formed by elevations on the respective surface 2, 8 so that the first and second device 1, 7 can be released from each other again. The elevations can also serve as distance elements to ensure a spacing between the first and second devices 1, 7. The support elements 12, 13 can also be realized by an elevation and a recess in which the elevation engages in the aligned condition.

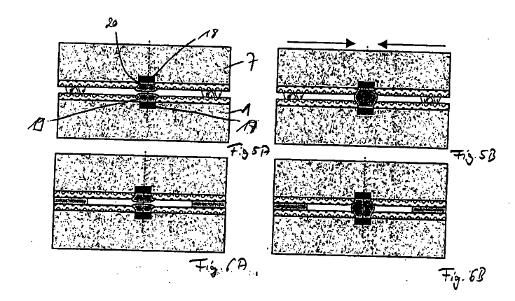

FIGS. 4A to 4D show a similar process of lowering the second device 7 onto the first device 1 wherein instead of the support elements 12, 13, a first adhesive element 14 on the first surface 2 of the first device 1 and a second adhesive element 15 on the second surface of the second device 7 is provided. While evaporating the droplet 6 as shown in the process states of the FIGS. 4B and 4C, the second device 7 is lowered onto the first device 1 so that the first and second adhesive elements 14, 15 come into contact such that the second device 7 is stuck to the first device 1 in the aligned condition achieved by the process state of FIG. 4C.

In FIG. 5A, a cross-sectional view of another portion of the first and second devices 1, 7 is shown wherein a first contact 17 on a first device 1 and a second contact 18 of the second device 7 are shown which face each other if the first and the second devices 1, 7 are in an aligned condition. Both the first contact 17 and the second contact 18 are applied with a respective solder bump 19, 20 with their surfaces close to each other if both the devices are aligned and the droplets removed.

An interconnection between the first and second contacts 17, 18 can be achieved by a reflow process wherein in the solder bumps 19, 20 are heated so that the solder melts and a single solder droplet is formed which remains in contact with the first and second contacts 17, 18. Thus, an electrical interconnection between the first and the second contacts 17, 19 is obtained (FIG. 5B). The evaporating of the droplet 6 and the reflow of the solder bumps can be carried out in a single heating process and the like.

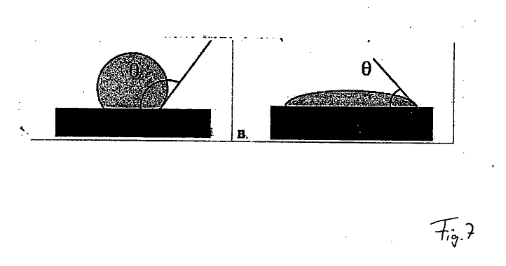

In FIGS. 6A and 6B, the same process is shown wherein instead of the support elements 12, 13 the first and the second adhesive elements 14, 15 are used.

In one embodiment of the present invention the second device is aligned on droplets having a predetermined arrangement and which may be placed on the surface 2 of the first device 1 or of another substrate in a predefined arrangement. By placing the second device 7 on the droplet, the second device 7 floats on the droplets 6 with respect to its second adjusting structures 9 such that the second device 7 is aligned with respect to the arrangement of the droplets 6 according to the physical effect described above. Thereafter, the droplets are preferably removed by a heating process so that the second device 7 is lowered onto the surface 2 of the first device 1. Preferably, the second device 7 can be fixed by means of support elements or adhesive elements and such like so that the aligned condition can be maintained against a lateral sliding. The high precision of the alignment of the second device 7 with regard to the surface beneath is achieved in spite of using a conventional pick-and-place technology having a lower accuracy for placing the second device 7 on the droplets 6. What should be taken into account is that the placing precision of the second device 7 on the droplets should be in such a way that the contact region between the droplet and the second surface of the second device 7 at least partially covers the third region of the second adjusting structure 9.

As illustrated in FIG. 7A and 7B, the wettabilities of different material layers are usually described with the term “wetting angle” which indicates the angle between a surface and the tangent of the droplet at the boundary between the droplet and the surface. A wetting angle below 90° (FIG. 7B) corresponds to a hydrophilic behaviour and a wetting angle of more than 90° (FIG. 7A) corresponds to a hydrophobic behaviour of the surface material. Possible materials for the first material layer (hydrophobic) of the first region 4 and the third region 10, respectively, include bioverite, tempax, silicon, silicon-dioxide, silicon-nitride, nickel and glass. Suitable materials for the second material layer (hydrophobic) of the second region 5 and the fourth region 11, respectively, may include Teflon, polytetrafluoroethylene (PTFE), ESSCOLAM 10, perfluorodecanithiol (PFDT) —modified rough gold surface, optical coatings with an enhanced roughness for ultrahydrophobic, low scatter applications, paraffin, poly(dimethylsiloxane) (PMDS).

As a material for the liquid of the droplet, the most preferred material is purified water but also other materials such as alcohol and such like may be appropriate which can be evaporated as removed without remainders.

While the foregoing is directed to embodiments of the present invention, other and further embodiments of the invention may be devised without departing from the basic scope thereof, and the scope thereof is determined by the claims that follow.

What is claimed is:

1. A method for aligning a device, comprising:
providing the device having a surface on which an adjusting structure is provided in predetermined regions of the surface, wherein the adjusting structure has a first region having a first wettability and a second region having a second wettability, wherein the second wettability is lower than the first wettability;
providing a liquid droplet in a fixed arrangement which corresponds to the arrangement of the adjusting structure in the predetermined regions; and
placing the device in contact with the liquid droplet in such a way that the droplet at least partially abuts the first and second regions of the corresponding adjusting structure and wherein the first and second wettabilities are selected to cause the relative lateral movement of the droplet and the device until the droplet and the device terminate in a predetermined aligned position relative to each other, the predetermined aligned position being defined by the adjusting structure.

2. The method of claim 1, wherein the liquid of the droplet is selected to have a surface tension that allows the device to be suspended on the droplets.

3. The method of claim 1, wherein the liquid of the droplet is selected to have a surface tension that accommodates free lateral movement between the device and the droplet.

4. The method of claim 1, wherein the droplet is defined by a plurality of droplets, wherein a number and a size of the plurality of droplets are selected in such a way that the device floats freely on the droplets.

5. The method of claim 1, wherein the size of the droplet is selected according to a weight of the device.

6. The method of claim 1, further comprising removing the droplet, whereby the device is lowered in the predetermined aligned position.

7. The method of claim 6, wherein the droplet is removed by evaporating the liquid of the droplet.

8. A method for aligning devices, comprising:
providing a first device having a surface on which a first adjusting structure is provided in a predetermined region of the surface, wherein the first adjusting structure has a first region having a first wettability and a second region having a second wettability, wherein the second wettability is lower than the first wettability;
providing a second device having a surface on which a second adjusting structure is provided in a predetermined region of the surface, wherein the second adjusting structure has a first region having a third wettability and a second region having a fourth wettability, wherein the fourth wettability is lower than the third wettability;
applying a liquid droplet at least partially contacting the fist region and second region of the first device, wherein the liquid droplet and the first device are laterally motivated relative to each other, at least in part as a result of a difference between the first wettability and the second wettability of the adjusting structure of the first device, until the droplet and first device reach a first terminal aligned position relative to each other; the first terminal aligned position being defined by the first adjusting structure of the first device; and
placing the second device on the liquid droplet in such a way that the liquid droplet at least partially contacts the first region and second region of the second device, wherein the liquid droplet and the second device are laterally motivated relative to each other, at least in part as a result of a difference between the third wettability and the fourth wettability of the second adjusting structure of the second device, until the droplet and second device reach a second terminal aligned position relative to each other; the second terminal aligned position being defined by the second adjusting structure of the second device.

9. The method of claim 8, wherein the first regions of the respective devices are recessed relative to the respective second regions.

10. The method of claim 8, wherein a respective pattern of the respective adjusting structures of the first and second devices corresponds to one another.

11. The method of claim 8, wherein the liquid droplet is selected to have a surface tension that allows the first and the second devices to be spaced from one another by a predetermined height when the droplet is centrally aligned with the respective first regions of the adjusting structures.

12. The method of claim 8, wherein the liquid droplet comprises a plurality of droplets having a number and a size selected so that the first and the second device are spaced from one another by a predetermined height when the plurality of droplets is aligned with the respective first regions of the respective adjusting structures.

13. The method of claim 12, wherein the size of the droplets is selected depending on a weight of the second device.

14. The method of claim 8, further comprising removing the liquid droplet so that the second device is brought into contact with the first device in a state of relative alignment.

15. The method of claim 14, wherein the droplet is removed by evaporating the liquid of the droplet.

16. The method of claim 8, wherein the first and third wettabilities are the same and the second and fourth wettabilities are the same.

17. A self-aligning device, comprising:
a substrate; and
an adjusting structure arranged on a surface of the substrate; the adjusting structure having a first region with a first wettability and a second region with a second wettability, wherein the second wettability is lower than the first wettability; wherein the first region defines a liquid retention area adapted to receive and retain a liquid during an alignment process and wherein a difference in the first and second wettabilities is selected to cause relative lateral movement of the liquid and the substrate until the liquid is located in a terminal position in the liquid retention area.

18. The device of claim 16, wherein the second region surrounds the first region.

19. The device of claim 16, wherein the second region surrounds the first region and wherein the first region is circular.

20. The device of claim 16, wherein the first region is recessed relative to the second region.

21. A self-aligning device, comprising:
1) a first device comprising:
a first substrate; and
a first adjusting structure arranged on a surface of the first substrate; the first adjusting structure having a first region with a first wettability and a second region with a second wettability, wherein the second wettability is lower than the first wettability; wherein the first region defines a first liquid retention area adapted to receive and retain a liquid during an alignment process and wherein a difference in the first and second wettabilities is selected to cause relative lateral movement of the liquid and the first substrate until the liquid is located in a terminal position in the first liquid retention area; and
2) a second device comprising:
a second substrate; and
a second adjusting structure arranged on a surface of the second substrate; the second adjusting structure having a first region with a third wettability and a second region with a fourth wettability, wherein the fourth wettability is lower than the third wettability; wherein the first region of the second adjusting structure defines a second liquid retention area adapted to receive and retain the liquid during the alignment process and wherein a difference in the third and fourth wettabilities is selected to cause relative lateral movement of the liquid and the second substrate until the liquid is located in a terminal position in the second liquid retention area; wherein the when the liquid located in the terminal position in the first and second liquid retention areas, the first and second substrate are in a predefined relative aligned state.

22. The device of claim 21, wherein the respective second regions surround the respective first regions.

23. The device of claim 21, further comprising respective retaining elements disposed on the first and second substrates and adapted to hold the first and second devices against each other in the predefined relative aligned state.

24. The device of claim 21, wherein the second region surrounds the first region and wherein the first region is circular.

25. The device of claim 21, wherein the first region is recessed relative to the second region.

26. The device of claim 21, wherein the first and third wettabilities are the same and the second and fourth wettabilities are the same.
